(19) United States
(12) Patent Application Publication
(10) Pub. No.: US 2016/0034908 A1
(43) Pub. Date: Feb. 4, 2016

(54) Employee Certification Management System

(71) Applicant: Dallas Wayne McClain, Leesburg, VA (US)

(72) Inventor: Dallas Wayne McClain, Leesburg, VA (US)

(21) Appl. No.: 14/450,254

(22) Filed: Aug. 3, 2014

(51) Int. Cl. G06Q 30/00

(52) U.S. Cl. CPC G06Q 30/018

(57) ABSTRACT

The Employee Certification Management System allows an organization to monitor the certification records of employees. Employee records are unique and require certifications relative to the department they are working in. This system also stores required certification documents and allows them to be downloaded by employees. An employee may log on and request supervisor approval for certifications. A supervisor may log on and approve required certifications or add additional training. Reports can be displayed on screen or printed as formatted PDF files for each employee. A system administrator has full control over the system through a built in interface.

### BACKGROUND

This system was developed for the ISO certification auditing standards for large-scale corporations. It was designed to allow companies a simple way to monitor the certifications and training of all employees as well as manage the certifications and training required throughout the organization.

### BRIEF SUMMARY

The Employee Certification Management System was developed to allow an organization an effective way to provide important work instructions and procedures to its employees. These documents are stored in the system and can be updated or modified at any time. When an employee accesses a document they are always receiving the most recent file. This system also allows for the monitoring of the training on these documents for auditing purposes.

### BRIEF DESCRIPTION OF THE DIAGRAMS

The above and other features of this invention are described in the following Detailed Description and shown in the following drawings:

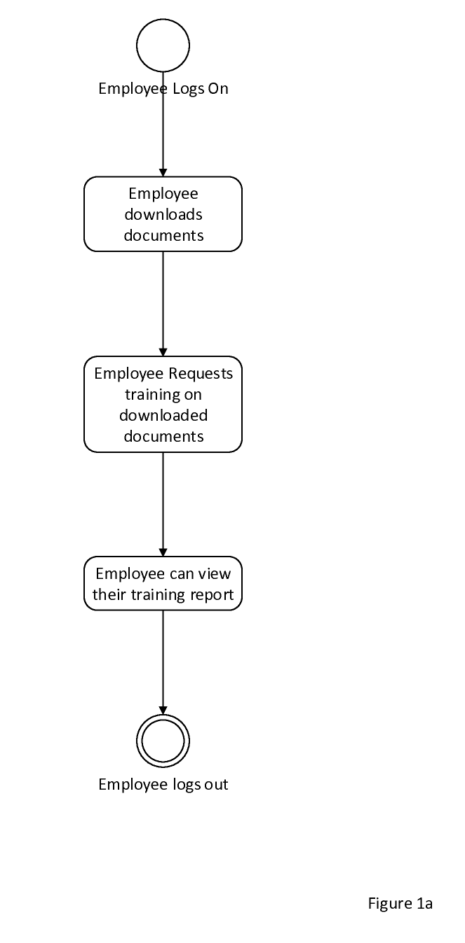

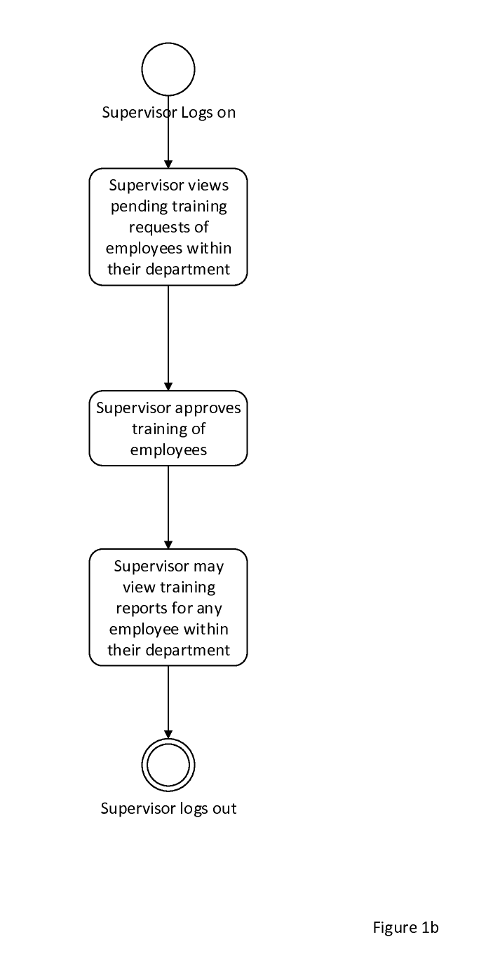

FIG. 1a illustrates a flow diagram where an employee would interact with the system to request and view certifications and training.

FIG. 1b illustrates a flow diagram where a supervisor would interact with the system to approve employee certifications and training.

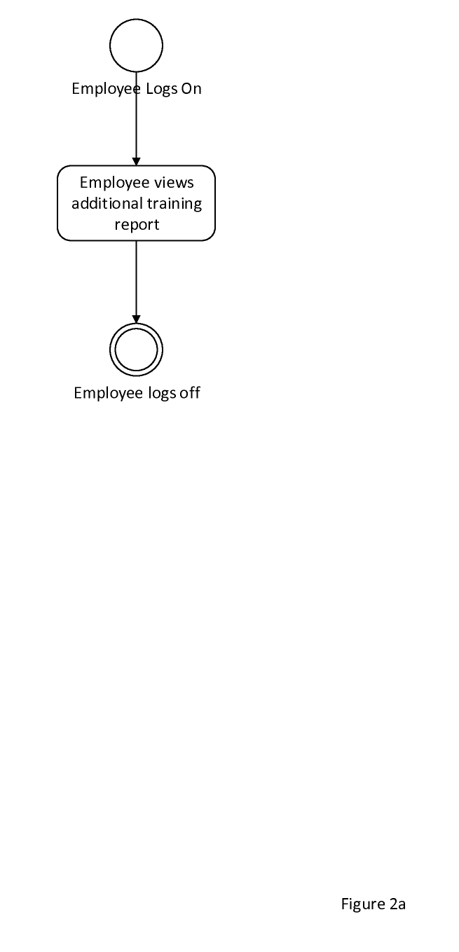

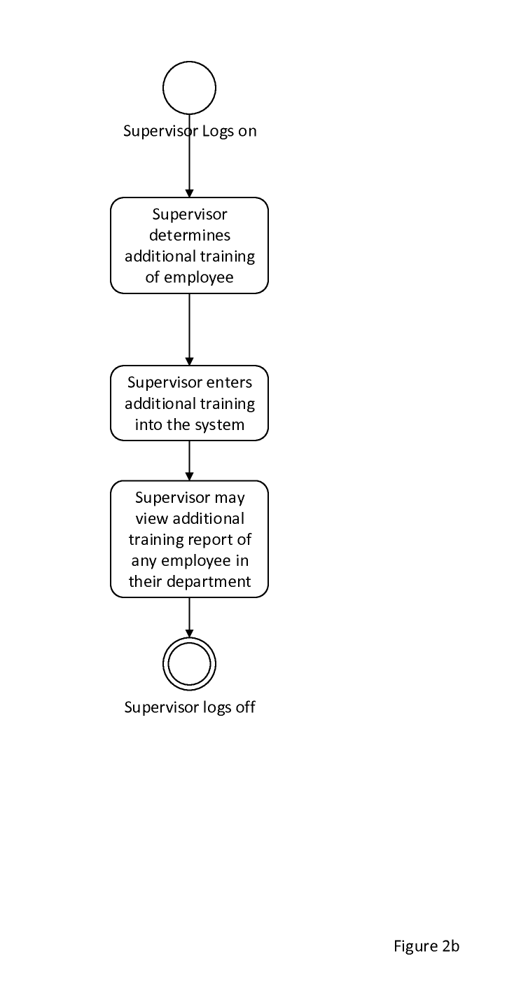

FIG. 2a illustrates a flow diagram where an employee would interact with the system to view any non certification related training.

FIG. 2b illustrates a flow diagram where a supervisor would interact with the system to record any additional training an employee has received.

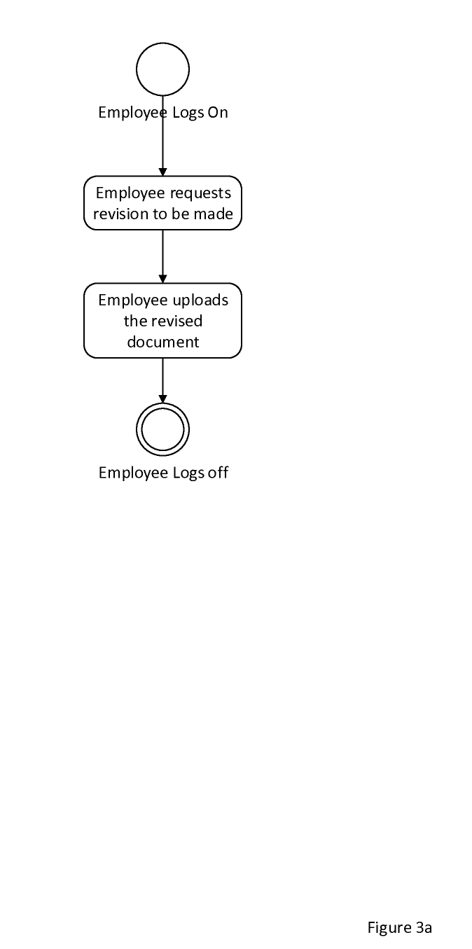

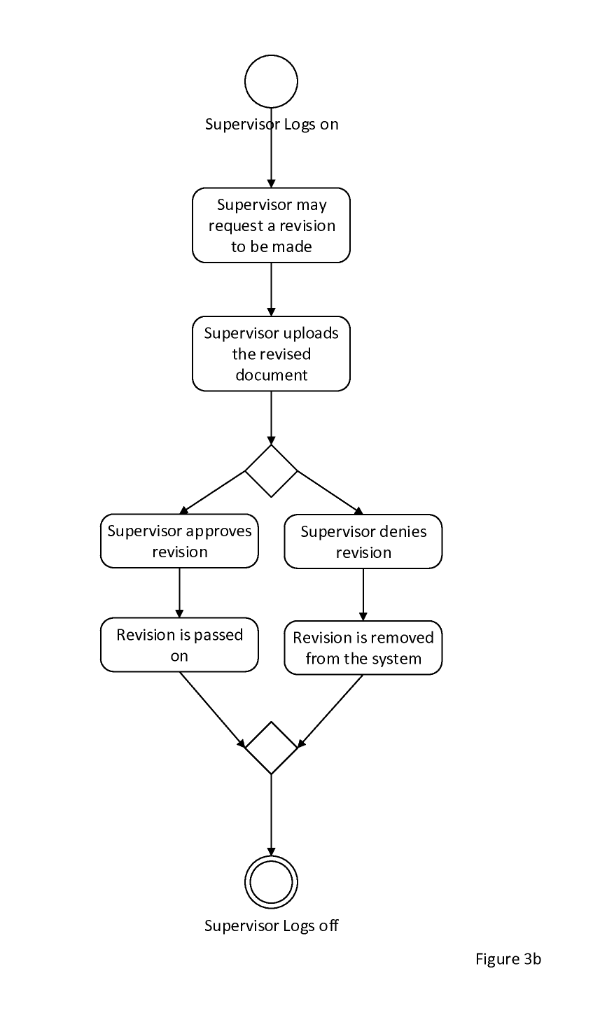

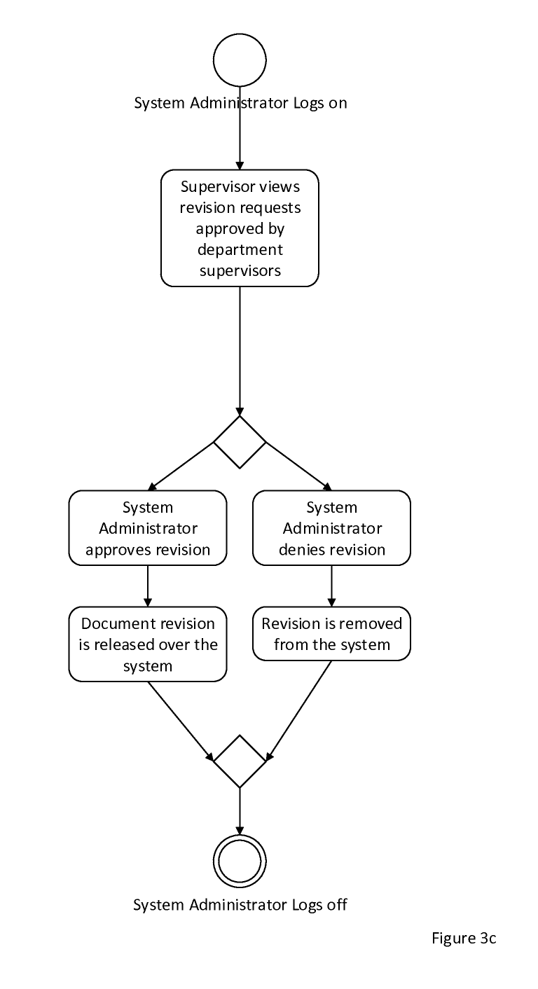

FIG. 3a illustrates a flow diagram where an employee interacts with the system to request an update to a certification document in the system.

FIG. 3b illustrates a flow diagram where a supervisor interacts with the system to approve or deny a revision to a certification document.

FIG. 3c illustrates a flow diagram where the system administrator interacts with the system to give the final approval or denial of a revision to a certification document.

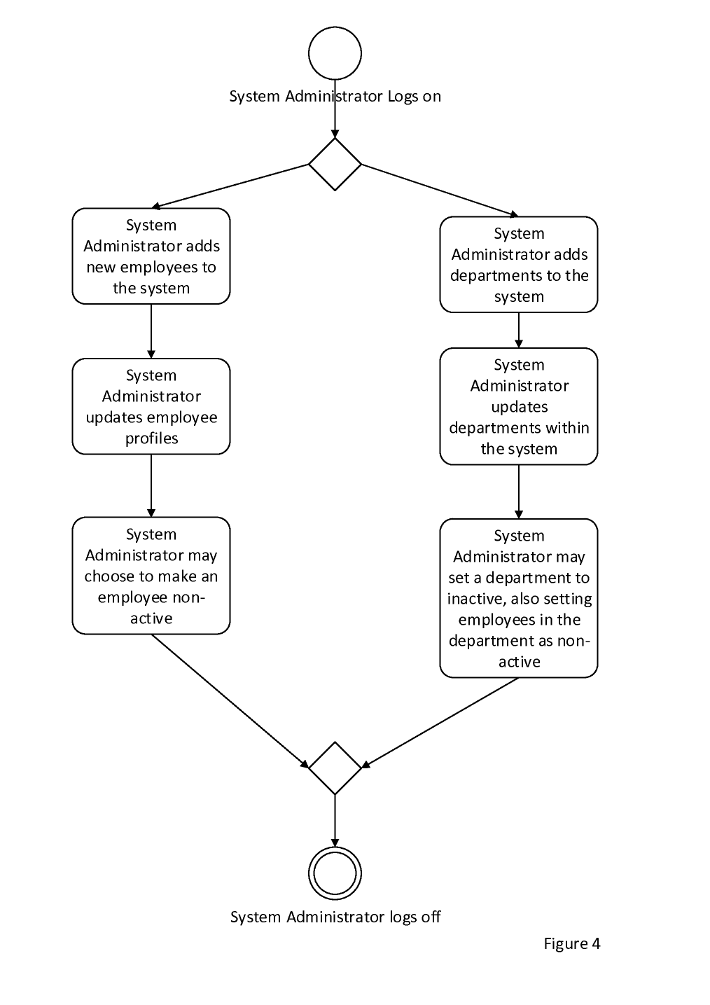

FIG. 4 illustrates a flow diagram where the system administrator interacts with the system to set up the business structure including employees needing certifications.

### DETAILED DESCRIPTION

Documents

Documents are stored in the system and can be accessed for employee certification purposes. Each individual document contains information about who manages the document, which department must be trained on the document, what the primary function of the document is, what the document's revision number is and miscellaneous other data. The documents on the system contain detailed reports of how to perform job activities. These reports are required for employees to know. This system allows employees an easy way to access these documents as well as manage the training on them.

Adding Documents

There are two steps to add a document to the system. The first step is to create the record. The system will prompt the System Administrator to enter all of the data specific to the individual document. Once this information is stored on the system, the Administrator is automatically prompted to browse their computer for the target document to upload to the server. This is the second and final step in adding a new document to the system. The system saves the document on a server and records all of the data for the document into the database.

Downloading Documents

There are several ways to access the documents from the system. The easiest way to access a document is through the Documents page from the navigation menu. Documents are grouped together by their primary function and can be downloaded to the user's computer. When a user downloads a document, the action is stored in the system. This action is required to be stored so that when an employee submits a certification request to his supervisor, he may only submit training on a document he has accessed and viewed.

Revise Documents

A document in the system can be revised at any time. A revision request can be sent in by any user and must have an updated document attached as well as a description of the updates. Once the request is sent, the manager(s) in charge of the document are notified and must accept or deny the revision request. If the revision is denied, the supervisor must include a reason why, which is sent to the employee who requested the revision. If the revision is approved, it is passed to the Document Coordinator for final approval. Once the final approval is made, the old document is stored in a directory for revised documents, the new file is moved to the document's primary file location, the revision number of the document is updated in the database, and an email is sent out to every department that requires training on the document. When the new revision of a document is released, it will clear all the employee certifications for the document in the database, forcing employees to be re-certified on the document. A revision should be submitted if the procedure of the document has changed or if the document properties stored in the system need to be modified.

### Obsolete Documents

To obsolete a document is to remove it from the system. When submitting a request to obsolete a document, the document can't have any references to other documents or be referenced by another document. Revisions must be made so that this is true. An employee may then select a document and input why it should be obsoleted. Once the obsoletion request is submitted the supervisor(s) in charge of the document can approve or deny the request. If the request is denied the supervisor is prompted to explain why, and an email is sent to the employee who requested the obsoletion. If the request is approved it is passed to the Document Coordinator for the final approval. When an obsoletion request is approved, the document is set to “inactive” in the system. Inactive documents are not displayed for download, they do not show up as being required for training, and they do not show up in training reports.

Training

This system is designed to monitor the certifications and training of employees within an organization. There are two major types of training: Required certifications and Additional training. This system allows employees and supervisors to record and manage their job training digitally while maintaining integrity of all parties involved.

Required Certifications

Required certifications deals with documents that an organization requires specific employees to know. These documents are stored in the system and are accessed by employees. The certifications are broken down by department. Each department has a different list of documents that employees within the department are required to know. Employees that are located in multiple departments have a different account for each department.

Request Certification

An employee must log onto the system in order to request certification on a document. For an employee to request certification, they must have downloaded and read through all the documents they wish to be certified on. Once the request has been submitted it is stored on the system until a supervisor approves the request.

Approve Certification

A supervisor is required to log on and approve an employee's certification request. The certification can only be approved for documents an employee has requested. Requests can be approved or denied. If denied, the employee is notified and must re-submit a certification request. If approved, the employee is marked as being “certified” on the document in the system. The document will no longer show up on the employee's list of documents to request certification on. The training record contains the date of the approval and which supervisor approved the training.

Certification Report

Reports can be printed for an employee containing a list of all their required certifications. Documents are listed along with certification status, date of certification and approving supervisor. There is an option to download this report to a PDF document. This allows employee records to be saved on a computer or to be printed off when an auditor comes.

Additional Training

The additional training portion of the system deals with non-required training an employee may have that is beneficial to their job. The additional training is stored at a different location than the required training. The system stores data relative to the additional training such as: date of training, employee who received the training, the training name, the training description, and the supervisor who approved the training. Reports can be generated for an employee's additional training.

Create Additional Training

Additional training is not requested by an employee, rather it is created for an employee by their supervisor. When an additional training record is made, the supervisor must enter the name of the additional training, the date it took place, the employee who received the additional training, and a description of the training. A supervisor may only create an additional training record for an employee who is in their department.

Display Additional Training

Additional training is printed to a report in a similar style as the required training. This report is employee specific and displays all of their additional training, including the name of the training, the date of the training, and the description of the training. This report may be saved as a PDF document.

System Management

The system is controlled by a complex management menu. This menu allows the administrator full access to controls that monitor and control every aspect of the system. This allows for everything to be controlled without a large knowledge of programming. The management menu and functions are only visible and accessible by an employee who has administrative privileges on the system.

Document Management

Documents are managed in two portions of the site. The first part of document management is in the creation of new documents. When a new document is created, the administrator must input information on the document they are adding to the system. This information includes: document ID, document name, document primary function, departments using the document, document file type and departments managing the new document. Once these variables have been entered the administrator will then be asked to upload the document to the system from a file on their local computer. The system will take this file and store it. Once the file is in the system it can be accessed by any employee from the documents section of the system. Documents in the system can be modified through the manage documents menu selection. This will allow the administrator to select a document. Once a document is selected, a form is pulled up containing all of the document properties found on the system. This is where document references will be set as well as any document name changes must take place. When a revision of a document is released by the document coordinator, they must come to the management documents page to make any applicable changes to the document properties.

File Extensions and Functions

Document extensions and primary functions are stored in the system. When a new document is created, or an existing document is modified, the options available for the file extension and the primary functions are stored in a drop down list. This prevents any typological errors. These lists can be modified by a system administrator.

Templates

Templates are stored in the system for when an employee wants to create a new training document. These templates are added through the management portion of the system. Because a template does not require training, additional document information is not required to be stored on the system. When a template is uploaded, the administrator is simply prompted to select the file from their computer and upload it to the system. Templates already on the system can also be removed. Templates are stored in a different directory in the system from the other documents and files.

Department Management

Business departments play a key role in this training system. Employees are sorted into different departments, and where appropriate some employees can even be listed in multiple departments. Each department in the system has a unique list of documents that are required for department employees to be trained on. When a department is created on the system, the administrator must enter the department name as well as the department supervisor's employee ID. The employee ID is important for creating employee profiles when logging into the system. If the user is a supervisor they will have different privileges than other users including: the ability to print reports of any employee in the department, the ability to view employee training certification requests and approve employee training, and the ability to approve document revision requests and obsoletion requests. Once a department is in the system, the system administrator has the power to update information on the department. When updating a department the administrator can change the supervisor ID. This change would be made if a new supervisor was put in charge of a department. The administrator also has an option to close a department. This makes the department inactive on the system, and also removes all of the employees in the department (by setting them to inactive as well). This would be done if a department was merged or disbanded.

Employee Management

The system administrator will create an account for every employee in the organization. These accounts include information such as: employee ID, employee name (first and last), employee department and the employee type. Each employee ID will have only one department tied to it, therefore if an employee is in multiple departments, they will be given separate IDs for each department. These IDs are tied together by the employee name, which includes the first and last name, and will not change between these employee IDs. An employee is, by default, set to active within the organization. The employee accounts can be modified by the administrator. For an employee to be modified the administrator must select a department, from which a list of employees is generated. Once the employee is selected, the administrator can set the account type of the employee or amend any information as required.

System Review

The data on the system can be checked at any time by the administrator. This information is returned in tables on the site and contains employee information as well as document information. The administrator can view pending revision requests, pending obsoletion requests, employee data for every employee in the organization and document revision data. Because this is an automated system, every action is recorded and able to be reviewed.

1. A computer program product for employee required certifications comprising of instructions on how employees, supervisors, and system administrators interact to determine and store information on employee required certifications within the program

2. A system, as in claim 1, wherein each employee has a unique ID

3. A system, as in claim 1, wherein each employee ID is tied to a specific department

4. A system, as in claim 1, wherein each department has a specific supervisor

5. A system, as in claim 1, wherein each company, department, reporting unit, or cash-generating unit has a list of documents required for certification

6. A method, as in claim 1, whereby the action of downloading documents by an employee is recorded

7. A system, as in claim 1, wherein employees may submit a certification request

8. A method, as in claim 7, whereby possible certification request are populated based on a document list specific to each type of company, department, reporting unit, or cash-generating unit

9. A method, as in claim 7, whereby possible certification requests are based on employee's approved training

10. A method, as in claim 7, whereby a certification request is submitted based on documents downloaded

11. A method, as in claim 7, whereby a certification request is submitted based on documents employee selects

12. A system, as in claim 1, wherein department supervisors may view pending certification requests

13. A method, as in claim 12, whereby certification requests are viewed based on department employee list

14. A method, as in claim 12, whereby certification requests are viewed based on a specific employee ID

15. A method, as in claim 12, whereby supervisors may approve pending certification requests

16. A system, as in claim 1, wherein reports are generated displaying required employee certifications

17. A method, as in claim 16, whereby employees may display their own report

18. A method, as in claim 16, whereby supervisors may display a report of any employee within their department

19. A method, as in claim 16, whereby reports based on department document list

20. A method, as in claim 16, whereby reports based on the approved certifications of the specific employee

21. A method, as in claim 16, whereby reports based on the supervisor that approved the document certification request

22. A computer program product for employee additional training comprising of a set of computer instructions to generate and store employee additional training in the program

23. A system, as in claim 22, wherein a supervisor may create additional training for a specific employee

24. A method, as in claim 23, whereby employee based on supervisor's department

25. A method, as in claim 23, whereby additional training for an employee has a specific name

26. A method, as in claim 23, whereby additional training for an employee has a unique description

27. A method, as in claim 23, whereby additional training for an employee has a specific date

28. A system, as in claim 22, wherein reports are generated displaying employee additional training

29. A method, as in claim 28, whereby employees may display their own report

30. A method, as in claim 28, whereby supervisors may display a report of any employee within their department

31. A method, as in claim 28, whereby reports based on specific employee ID

32. A computer program product for managing certification documents comprising of computer instructions on how documents are to be stored and updated within the program

33. A method, as in claim 32, whereby each document has a unique ID

34. A method, as in claim 32, whereby each document ID is tied to a name, file type, revision number, document type, primary function, managing department

35. A method, as in claim 32, whereby each document is stored in the system based on the document ID and the document type

36. A method, as in claim 32, whereby each document has a list of departments requiring certifications

37. A system, as in claim 32, wherein System Administrators may add new documents to the system

38. A method, as in claim 37, whereby to add a new document the system administrator must fill out the document properties

39. A method, as in claim 32, whereby to add a new document the system administrator must upload the document

40. A system, as in claim 32, wherein document revision requests may be submitted by any user

41. A method, as in claim 40, whereby document revision request based on document ID

42. A method, as in claim 40, whereby document revision request has a specific employee ID

43. A method, as in claim 40, whereby document revision request has an unique description

44. A method, as in claim 40, whereby document revision request contains the file containing revisions made

45. A method, as in claim 40, whereby document revision requests are approved by supervisor

46. A method, as in claim 40, whereby supervisor approving document revision request based on the specific managing department of the document ID

47. A method, as in claim 40, whereby system administrator releases revision once the supervisor has approved the revision request

48. A method, as in claim 40, whereby on revision release document properties are updated and the revised version of the document becomes active

49. A method, as in claim 40, whereby revision requests can be denied by supervisor or system administrator

50. A method, as in claim 40, whereby supervisor who denies revision request based on managing department of the document ID

51. Revision history may be viewed with information of every revision on any document

52. A computer program product for managing organizational data comprising of computer instructions for determining employee information and organizational department information and storing this information within the program

53. A method, as in claim 52, whereby employee accounts are created based on a unique employee ID

54. A method, as in claim 52, whereby each employee ID has a unique department

55. A method, as in claim 52, whereby employee list may be viewed containing information on each employee account

56. A method, as in claim 52, whereby departments are added to the system with a unique supervisor ID

57. A method, as in claim 52, whereby documents required for department certifications are managed based on document ID
